(19) United States
(12) Patent Application Publication
(10) Pub. No.: US 2011/0219440 A1
(43) Pub. Date: Sep. 8, 2011

(54) APPLICATION-LEVEL DENIAL-OF-SERVICE ATTACK PROTECTION

(75) Inventor: Nicholas Alexander Allen, Redmond, WA (US)

(73) Assignee: MICROSOFT CORPORATION, Redmond, WA (US)

(21) Appl. No.: 12/717,044

(22) Filed: Mar. 3, 2010

(51) Int. Cl. H04L 9/32; G06F 21/20; G06F 15/16

(52) U.S. Cl. 726/9; 726/13

(57) ABSTRACT

The gate guard filtering of incoming application-level requests on behalf of an application. Upon receiving an application request, a token found in the application request may be evaluated by the gate guard. This token may have been previously provided by the application, with instructions that future application requests by the client are to include the token. The gate guard classifies the incoming request as being a member of a subset of one or more application request classes. These identified request classes may be used to determine an admission policy to apply based on the particular subset of one or more request classes corresponding to the application request. The admission policy is then applied to the incoming application request to determine if the application request should be rejected or accepted. As another option, the application request may perhaps even be deferred for future determination of rejection or acceptance.

### BACKGROUND

A denial-of-service attack is an attempt to make a target Internet site or service unavailable to its intended users by preventing it from functioning efficiently or at all, temporarily or indefinitely. Denial-of-service attacks are considered violations of the Internet Architectural Board's (IAB's) proper use policy. Such attacks also violate the acceptable use policies of virtually all Internet Service Providers. They also commonly constitute violations of the laws of individual nations. Nevertheless, despite the unethical and often criminal nature of such acts, the acts do persist.

One common method of attack involves flooding the target site or service with external communications requests, such that it cannot respond to legitimate traffic, or responds so slowly as to be rendered effectively unavailable. Conventionally, these flooding attacks are often detected and blocked at low level protocols of the network stack. For instance, the Internet Protocol (IP) source address of IP packets may be examined to see if an unusually high number of requests are being received from a particular IP address.

One more recent type of denial-of-service attack is the distributed denial-of-service attack which increases the sophistication of flooding denial of service attacks by exploiting a set of other machines to make illegitimate requests to a target site or service. Such machines are often referred to as zombie machines because the machines often make such requests unbeknownst to its user(s) and often as a result of a virus. A collection of zombie machines acting together to formulate a flooding attack on a target site or service is often referred to as a “botnet”.

As another example of sophistication in denial-of-service attacks, it is increasingly common for a malicious individual to craft attack programs that subtly exhaust resources at the application level, and that are not detected by the low-level protocol checks for flooding attacks.

### BRIEF SUMMARY

At least one embodiment described herein relates to the filtering of incoming application requests on behalf of an application, some of the application requests being rejected, and some of the application requests being accepted. This filtering will also be referred to as gate guarding. The gate guarding occurs on application messages rather than at lower level of the protocol stack, and thus may optionally be used to supplement filtering on the lower protocol layers.

Upon receiving an application request, a token found in the application request may be evaluated by the gate guard. This token may have been previously provided by the application, with instructions that future application requests by the client are to include the token. As one example, the application may include information that the gate guard may consider in deciding whether to reject or accept future messages originating from the client that have the application as its destination. Such information might include, for example, observations regarding past behavior of the client with respect to the application

The gate guard classifies the incoming request as being a member of a subset of one or more application request classes. These identified request classes may be used to determine an admission policy to apply based on the particular subset of one or more request classes corresponding to the application request. The admission policy is then applied to the incoming application request to determine one of at least two possible outcomes including 1) rejecting the application request, and 2) accepting the application request. As an example, the token may be used to perform either or both of the classification of the request, or the determination of the admission policy to apply to the incoming application request based on the classification. Thus, the principles described herein allow the application which is the target of the application request to provide information to the gate guard in the form of the token returned by the requestor, so that the gate guard can use information from the application to determine whether to accept or reject that application request.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates various topologies that represent examples of how a gate guard may be deployed;

FIG. 3 illustrates a flowchart of a method for filtering incoming application requests for an application such that some application requests are rejected, and some application requests are accepted;

FIG. 4 schematically illustrates an example gate guard environment with various components and descriptive message flows that occur during the operation of the various components; and

FIG. 5 schematically illustrates a service that interfaces with the gate guard of FIG. 4.

### DETAILED DESCRIPTION

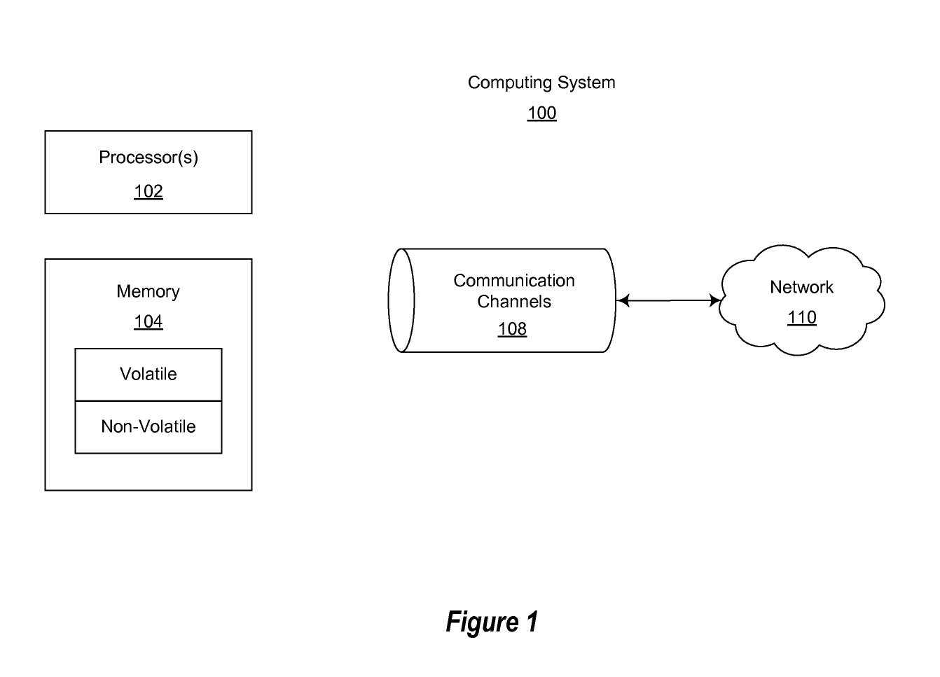

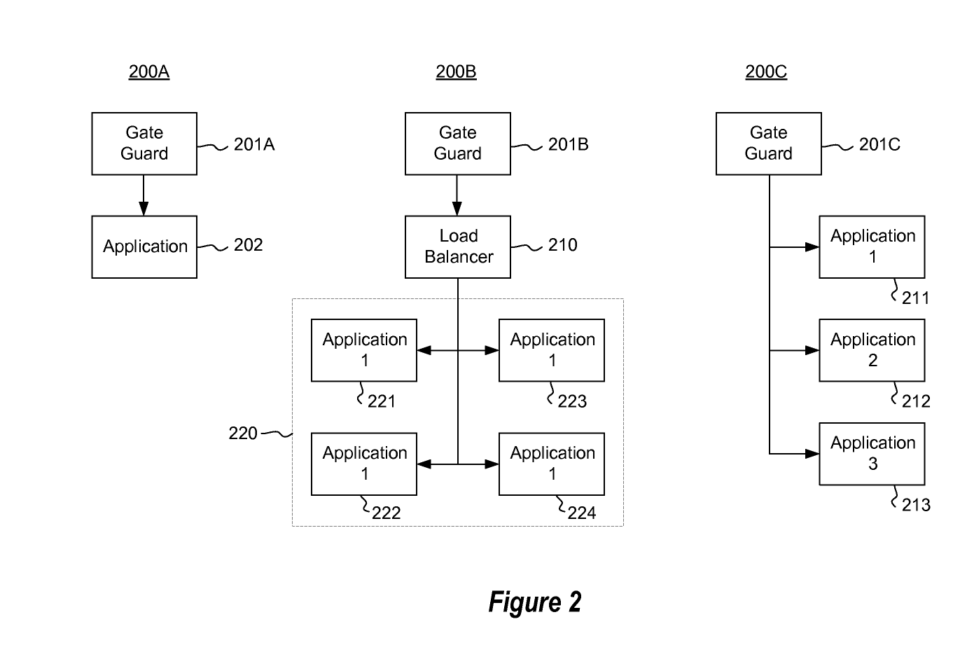

In accordance with embodiments described herein, a gate guard component filters incoming application-level requests on behalf of an application (e.g., a web service). The gate guard classifies the incoming request as being a member of a subset of one or more application request classes. These identified request classes may be used to determine an admission policy to apply based on the particular subset of one or more request classes corresponding to the application request. The admission policy is then applied to the incoming application request to determine if the application request should be rejected or accepted. The token may be used to help this determination. First, some introductory discussion regarding computing systems will be described with respect to FIG. 1. Then, various embodiments of the gate guard and its example operation will be described with reference to FIGS. 2 through 5.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media or “transitory” media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include a computer program product having computer-readable media for carrying or having computer-executable instructions or data structures stored thereon. Such computer-readable media (or machine-readable media) can be any available media that can be accessed by a general purpose or special purpose computer. By way of example, and not limitation, such computer-readable media can comprise physical non-transitory storage and/or memory media such as RAM, ROM, EEPROM, CD-ROM, DVD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. The computer-executable instructions cause the computer or processing device to perform the function or group of functions because the computer-executable instructions have a certain structure. If digitally represented, for example, such structures may represent one or more bits of information. In the case of magnetic storage media, for example, such as structure may be a level and/or orientation of magnetism on the media at predetermined parts of the magnetic storage media. In the case of optical storage media, for example, such a structure may be a level of reflectivity of the media at particular predetermined parts of the optical media.

The computing system 100 may execute an application gate guard that serves to automatically intercept application requests directed towards an application. As one example, the application might be a web service. The application request is intercepted at the application-level, upstream of the lower level protocols in the protocol stack, and may be used in conjunction with traditional lower-level protocol filters that guard against some types of flooding denial-of-service attacks.

FIG. 2 depicts a variety of topologies 200A, 200B and 200C for deploying a gate guard. For instance, the topology 200A shows that a single gate guard 201A may be connected with a single downstream application 202. The topology 200B shows that a single gate guard 201B may be connected to a farm 220 of instances 221, 222, 223 and 224 of an application through a load balancer 210 that distributes incoming requests from the gate guard 201B to the instances. As a final example, as shown by topology 200C, a single gate guard 201C may be connected to multiple downstream applications 211, 212 and 213. Of course, these are just example topologies as the gate guard in accordance with the principles described herein may apply regardless of the number of downstream applications it serves, and regardless of the number of instances of such applications.

In one embodiment, the gate guard may be deployed to a machine that is connected to a communication medium with potentially a much greater bandwidth than the application machine. In this configuration, the gate guard may provide brute-force flooding protection to the application machine by rejecting malicious requests before the application machine's inbound communication mediums become saturated.

Alternatively, the gate guard may be deployed to the same local machine as the application. In this configuration, the gate guard still intercepts requests directed towards the application and filters out requests that appear to be malicious. Although the gate guard has no leverage advantage in terms of bandwidth in this configuration, the gate guard may still aid the application by protecting against attacks that attempt to exhaust other types of resources, such as processing, network connections, memory, storage space, storage IO, and the capacity of backend services, such as databases and request processing systems.

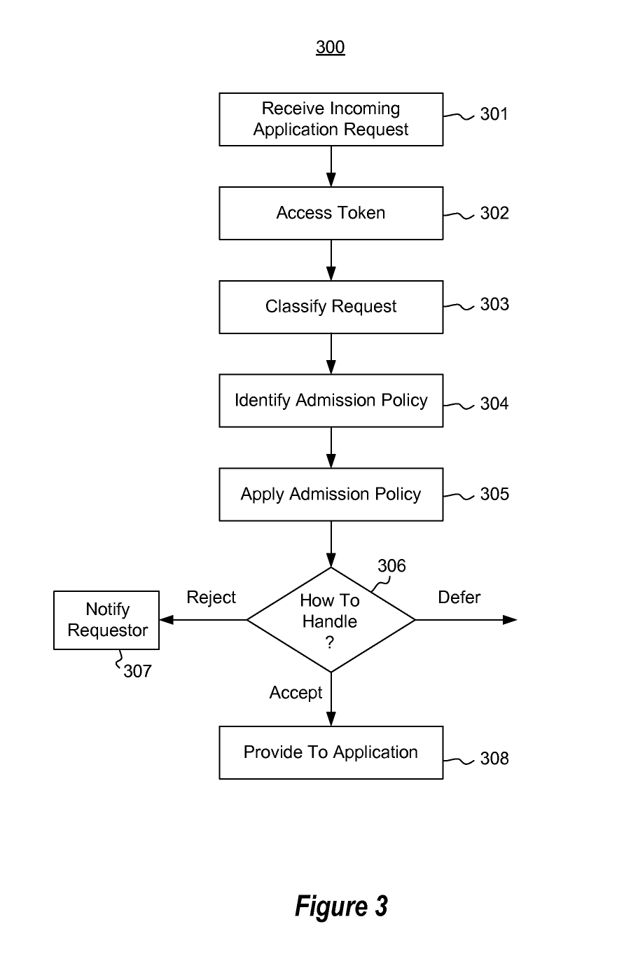

FIG. 3 illustrates a flowchart of a method 300 for filtering incoming application requests for an application such that some application requests are rejected, and some application requests are accepted. The method 300 may be performed by the gate guard, such as gate guard 201A, gate guard 201B, and gate guard 201C of FIG. 2, or any other gate guard that receives incoming application requests for a downstream application. The method 300 may be performed for each of at least some incoming application messages, but perhaps for each of all of the incoming application messages.

The method 300 is initiated upon receiving an incoming application request (act 301). The incoming application request has already passed through the lower levels of the protocol stack at this point, and may have already passed through appropriate filtering at that lower level in the protocol stack. An example of the application-level message is a web service request.

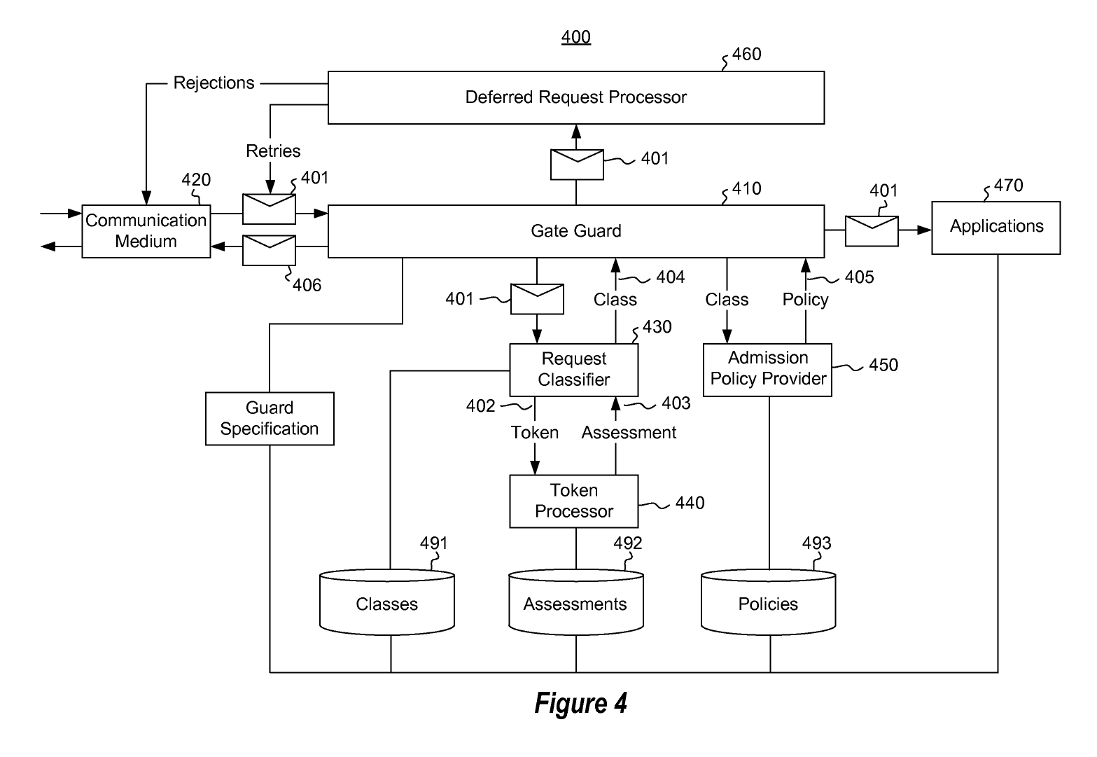

The method 300 will be frequently described with respect to FIG. 4, which illustrates an example gate guard environment 400 with various components and descriptive message flows that occur during the operation of the various components. For instance, the gate guard 410 receives an application level request 401 from a communication medium 420. The communication medium 420 may be a bi-directional communication medium in cases in which responses may be dispatched from the application, through the gate guard 410 back to the requestor. However, in cases in which communication is just one way with respect to the gate guard 410, the communication medium 420 may be perhaps just a one way communication medium.

Referring to FIG. 3, the gate guard then accesses a token from the incoming application message (act 302). The token was issued by the application as part of the application-level protocol. The application provides the token back to the requestor with the instructions that the requestor is to submit the token back to the application in future requests. In one embodiment, the token is decipherable based on information shared by the gate guard 400 and the application that is the destination of the application request, but the shared information is not known by the issuer of the application request. For example, the context token may be encrypted using a private key that the gate guard 400 and the application know but the requestor does not. Alternatively, the context token may be a reference into a look-aside table or database to which the gate guard 400 and the application have shared access but the requestor does not.

The gate guard 400 then deciphers the context token to obtain the application's assessment of the requestor. For example, the application may assess that the requestor is making an unusual number of expensive requests. As another example, the application may assess that the requestor is a batch job that runs once per night. If the application request does not include a context token, the gate guard may use a default assessment, such as that the requestor is an unknown entity.

The context token may include restrictions that determine whether the assessment is still valid. For example, the context token may be restricted to requests received within one hour of the context token having been issued. As another example, the context token may be restricted to requests received from a particular Internet Protocol (IP) address or range of IP addresses that the requestor has used in the past. If the context token restrictions are not met, the gate guard may choose to use a default assessment or may have particular request classes for requestors that provide invalid context tokens.

In FIG. 4, the gate guard 410 provides the incoming application request 401 to a request classifier 430, which may be the component that actually extracts and deciphers the token.

The gate guard 400 then classifies the application request as being of a particular subset of one or more request classes of a plurality of possible request classes (act 303). While a request might belong to a single request class, the principles described herein are also applicable should the request belong to multiple request classes. Referring to FIG. 4, the request classifier 430 provides the token 402 to a token processor 440, which uses an assessment store 492 to determine an assessment of the requestor based on the token. The token processor 440 then returns the assessment 403 to the request classifier 430.

Once the gate guard has obtained an assessment of the requestor, the gate guard then assigns the request to one of the previously created request classes. Referring to FIG. 4, the request classifier 430 assigns the request to one of the request classes represented in the class store 491 based on the assessment 403. The request classifier 430 then provides the identified class(es) 404 back to the gate guard 410.

This assignment of a request to a class or classes may be straightforward. For example, the assessment may be that the requestor appears to be making an unusual number of expensive requests and there may be a request class that directly corresponds to this assessment. Alternatively, the assignment may require the evaluation of rules to determine the proper request class. For example, the assessment may direct that the request be assigned to a low priority request class on weekdays and assigned to a normal priority request class on weekends. As another example, the gate guard may choose more than one request class to which the request may be assigned. The gate guard may then evaluate a function of the more than one request classes, such as using the most favorable or least favorable request class for the disposition of the request.

The gate guard 400 may be configured with a set of request classes that distinguish application user requests and an associated admission policy for each request class. In FIG. 4, for example, the admission policy provider 450 has access to a policy store 493, which lists service policies corresponding to each request class.

A potentially unlimited variety of criteria might be employed to define the set of request classes. As an example of request classes, these may include a request class for unknown requestors, a request class for requestors that issue long-running requests, a request class for low priority requestors, a request class for requestors that should only run in the evenings, a request class for requestors that invoke an unusual number of expensive operations, and so on.

Returning to FIG. 3, once the request class(es) corresponding to the incoming application request are identified, the gate guard determines an admission policy to apply based on the particular subset of one or more request classes corresponding to the application request (act 304). The admission policy may be dependent at least in part upon the content of the token included within the application request. The admission policy might also be dependent upon a status of the application 470 or a status of a computing system running the application 470. In FIG. 4, the gate guard 410 provides the identified class(es) 404 corresponding to the incoming application request to the admission policy provider 450. The admission policy provider 450 then uses the policy store 493 to identify the admission policy corresponding to the class(es). The admission policy 405 is then provided by the admission policy provider 450 back to the gate guard 410.

The set of request classes and associated service policies may be statically configured at the gate guard 410 or may be obtained dynamically from the application 470. For example, the gate guard may periodically receive a message, event, or signal from the application 470 that establishes a request class or assigns a service policy to a request class. The service policy assists the gate guard 410 in determining whether to admit, defer, or reject the request. The application 470 may also change the assessments for a given token.

A potentially unlimited variety of criteria might be employed to define the admission policies. As an example of an admission policy, requests from requestors that invoke expensive operations may be deferred unless fewer than ten requests were admitted in the previous minute, otherwise admitted. As another example of an admission policy, requests from requestors that should only run in the evenings may be rejected if the time of day is between 5 AM and 5 PM, otherwise deferred if the web service queue contains more than fifty requests, otherwise admitted.

The admission policy of the request class is then applied (act 305) to determine whether the request is to be admitted immediately, deferred for later evaluation, or rejected immediately (decision block 306). The admission policy controlling the disposition of the request may further incorporate a measure of the resources on the application machine. The gate guard may from time to time receive messages, events, or signals that indicate the status of resources available to the application machine. For example, the gate guard may receive updates on the number of requests being processed, the percentage of CPU time being used, the amount of free memory available, and so on.

When the gate guard fronts multiple applications or multiple instances of an application, the service policy may incorporate quality of service controls across the collection of applications or instances. For example, although a request class may have an admission policy that allows deferring up to fifty requests, there may be a restriction that any particular application can only occupy ten of those deferred request slots. As another example, the gate guard may receive resource updates from all of the application machines and have an admission policy that a request is to be admitted if at least one machine is using less than fifty percent of its CPU time.

Thus, the determination of the class and admission policy depends on the content of the token returned by the requestor to the gate guard. The gate guard may use assessments of the application itself that are derived from the token generated by the application. The assessments may be used to identify the class of the incoming application request, as well as the admission policy to use corresponding to that class.

In one embodiment, there are two possible outcomes of the application of the admission policy. One is to reject the application message (“Reject” in decision block 306). If the request is to be rejected, the gate guard may simply drop the request to minimize resources expended or may send a more informative error message to the requestor. For example, the gate guard may, in response to a SOAP request that is being rejected, transmit a SOAP fault to the requestor indicating that the client's request cannot be completed. In other cases, perhaps a notification is not desirable (act 307) if, for example, it appears that the requestor may be exercising malice, and such a notification would only serve to allow the requestor information to design around the rejection in future denial-of-service attacks, or allow the user to further exhaust network bandwidth by requiring the notification to be dispatched back to the requestor. In FIG. 4, the gate guard 410 is shown as providing notification 406 through the communication medium 420 back to the requestor.

As another option, the application of the admission policy may cause the gate guard to accept or admit the incoming application request (“Accept” in decision block 306). If the incoming application request is to be admitted, the gate guard transmits the request message to the application (act 308) over an outbound communication medium that connects the gate guard with the application. Quality of service and balancing of resources across applications may be incorporated into load balancing or the routing of requests from the gate guard to the particular web service instance. In the earlier example of admitting requests based on at least one machine having available CPU time, it may be a requirement to direct the admitted request to one of the machines that met the CPU time criteria.

In one embodiment, as a third possible option, the application of the admission policy may cause the gate guard to defer the application request (“Defer” in decision block 306). In that case, a decision as to whether to reject or accept the application request is deferred until a later time.

If the request is to be deferred, the gate guard places the request in a deferred request reevaluation order. In FIG. 4, the gate guard provides the incoming application request 401 to the deferred request processor 460. The placement of requests in the deferred request reevaluation order may behave like a queue for removal but may behave differently for insertion. The admission policy of a request class may dictate a partial ordering among the deferred requests. For example, the requests for a high-priority request class may be placed ahead of requests for a low-priority request class regardless of whether the low-priority requests were received first. When the gate guard fronts multiple applications or multiple instances of an application, the deferred request reevaluation order may be shared amongst the one or more applications by interleaving the placement of deferred requests.

A random adjustment factor may also be applied to the placement of deferred requests. For example, the admission policy for a request class may place the request tenth in the queue. However, a random adjustment factor may be applied to move the request upwards or downwards within the queue. The incorporation of a random adjustment factor may help prevent starvation by allowing requests that would be placed later in the queue to jump ahead, with some suitably low probability, of a continuous incoming stream of requests that would be placed earlier in the queue.

As another example, random replacement may be used when the queue is full. When the queue is full, the gate guard may select a position for the deferred request as normal. If the selected position places the deferred request beyond the maximum bound of the queue, the request is rejected instead of deferred. However, if the selected position places the deferred request within the queue, the request previously located in that spot is rejected instead. When the gate guard is being flooded with malicious requests, random replacement may allow legitimate requests to continue to be processed as the probability of replacing a common malicious request with an uncommon legitimate request is high, while the probability of selecting an uncommon legitimate request for replacement is low.

From time to time, the gate guard draws deferred requests to reevaluate whether they should be admitted, rejected, or placed anew in the deferred request reevaluation order. The gate guard may enact a variety of policies for deciding when to reevaluate requests. For example, the gate guard may draw a request from the deferred requests only when no new request needs to be processed. As another example, the gate guard may draw requests from the deferred requests interleaved with new requests, such as after every other new request or after every few seconds.

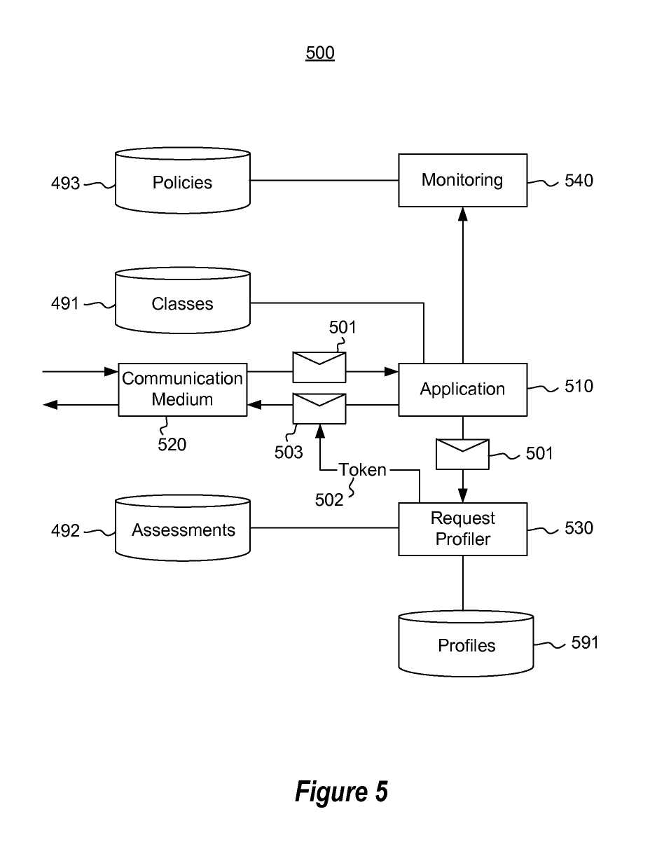

Turning now to describe the downstream applications, the operational components of an application that interact with a gate guard are shown in FIG. 5. The application may from time to time send a message, event, or signal to the upstream gate guard that establishes a request class, assigns admission policies to a request class for admitting, deferring, or rejecting requests, or informs the gate guard of the current resources available at the application system. These interactions between the application and gate guard may be independent of actions taken to receive and process requests.

The application receives requests over an inbound communication medium as it naturally would. In FIG. 5, for example, the application 510 receives the incoming application request 501 from the inbound communication medium 520. When the gate guard is deployed however, these requests are first intermediated. The application 510 may also have one or more other inbound communication mediums either intermediated by different gate guards or not intermediated by a gate guard. Therefore, the requestor and application may continue to function normally regardless of whether the gate guard is present, although the exchanged context token may perhaps have no effect when the gate guard is not being used.

The incoming application request 501 may contain a context token that was previously issued by the application as part of an application-level protocol. Similar to the gate guard, the application may decipher the context token to obtain its previous assessment of the requestor or may choose to ignore the context token and evaluate the requestor anew. The application may use other information that it has recorded about the requestor, such as a record of past connections from the requestor's address, past method calls from the requestor in the application session, or the like.

The application then constructs an assessment of the requestor. For instance, the service 510 may provide the incoming application message 501 to the request profiler 530, which uses prior profile information 591 to formulate an assessment of the requestor. The assessment may be provided to the assessment store 492 of FIG. 4. For example, the application may calculate a statistical profile of the requestor's past behavior to compare with other statistical profiles. The application may notice the requestor has a perceived pattern of creating an unusual number of application sessions, and note this in its assessment. Other perceived patterns that the application may recognize include a perceived pattern of issuing requests at particular times, a perceived pattern of issuing requests at particular rates, a perceived pattern of issuing requests for particular capabilities, or a perceived similarity between the requestor and a particular requestor profile.

A perceived similarity between the requestor and a particular requestor profile may be based on a profile crafted by an administrator. Alternatively, the administrator may have captured a log of requests from requestors to generate profiles of these requestors using a requestor profile analyzer.

The application then enciphers the context token 502 so that it can be understood by the gate guard but not by the requestor. For example, the context token may be encrypted using a private key that the gate guard and application know but the requestor does not. Alternatively, the application may generate a unique context token and write its meaning into a look-aside table or database to which the gate guard and application have shared access but the requestor does not. The context token may further include restrictions that determine whether the assessment is still valid. For example, the context token may be restricted to requests received within one hour of the context token having been issued. As another example, the context token may be restricted to requests received from a particular IP address or range of IP addresses that the requestor has used in the past.

As part of formulating the new context token 502 the application may invalidate one or more previously issued context tokens. For example, the application may change the assessment for a previously issued context token that has been returned by the requestor to indicate that further use of the previously issued context token is to be interpreted as a context token replay attack.

The application then encodes the context token into a response message 503 using an application-level protocol. The application-level protocol indicates that the requestor should return the context token with future requests. However, the application-level protocol may be completed even if the context token is not present. For example, HTTP cookies are an example of a mechanism for exchanging context in this fashion.

The response message may be an application response for the initial request. Alternatively, the response message may be a protocol message for the purpose of exchanging request tokens. Using an application message may reduce the total number of messages exchanged between the requestor and application. In contrast, using a protocol message may help mitigate flooding attacks by requiring a malicious requestor maintain state about each issued request since the application does not perform significant work until the context token is returned.

Finally, the application transmits the response message 503 to the requestor over an outbound communication medium 520. The application may use the gate guard as a proxy that intermediates communication in both directions. Alternatively, the application may use an outbound communication medium that directly connects to the requestor.

A monitoring component 540 may monitor interactions with the application 510, and alter admission policies 493 based on the interactions. For example, the monitoring component 540 may periodically measure the amount of idle processing time, free memory, number of queued requests, or other application health information statistics and alter the admission policies 493 based on the results of these measurements.

Accordingly, an advanced and flexible mechanism has been described for guarding against malicious incoming messages destined for downstream applications. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A non-transitory computer program product comprising one or more physical non-transitory computer-readable media having thereon computer-executable instructions that, when executed by one or more processors of the computing system, cause the computing system to filter at least some incoming application requests for an application such that some application requests are rejected, and some application requests are accepted by performing the following for each of the at least some incoming application requests:
an act of classifying the application request as being of a particular subset of one or more request classes of a plurality of possible request classes, wherein the application request includes a token issued by the application, which token is decipherable based on information shared by the computing system and the application, but the shared information not being known by the issuer of the application request;
an act of determining an admission policy to apply based on the particular subset of one or more request classes corresponding to the application request, wherein the admission policy is dependent at least in part upon content of the token included within the application request; and
an act of applying the determined admission policy for the application request, the application of the admission policy having at two possible outcomes including 1) rejecting the application request, and 2) accepting the application request.

2. The computer program product in accordance with claim 1, wherein the application of the admission policy has at least three possible outcomes including deferral of the application request in which a decision as to whether to reject or accept the application request is deferred until a later time.

3. The computer program product in accordance with claim 2, wherein the deferred application messages are placed in the deferred message pool in accordance with a priority of the deferred application message.

4. The computer program product in accordance with claim 2, wherein the deferred application messages are placed in the deferred message pool with some randomization.

5. The computer program product in accordance with claim 2, wherein the deferred application messages are drawn at selected times from the deferred message pool for reevaluation.

6. The computer program product in accordance with claim 1, wherein for at least one of the application requests that is accepted, the application issues an application response to the requestor that includes a token, the response token responsive to the application request and the received token.

7. The computer program product in accordance with claim 6, wherein the received token is marked as having been returned to the application, wherein the classification of a subsequently received application request bearing the received token depends on the received token having been marked.

8. The computer program product in accordance with claim 1, wherein for at least one of the application requests that is rejected, a requester is notified of the rejection.

9. The computer program product in accordance with claim 1, wherein the admission policy is dependent upon a status of the application or a status of a computing system running the application.

10. The computer program product in accordance with claim 1, wherein the admission policy is dependent upon a time.

11. The computer program product in accordance with claim 1, wherein the classification of the application request depends on the content of the token thereby causing the admission policy to be dependent upon the content of the token.

12. The computer program product in accordance with claim 1, wherein the act of determining an admission policy to apply based on the particular subset of one or more request classes comprises one of: determining a set of admission policies corresponding to each of the one or more request classes and selecting an admission policy at least as restrictive as the most restrictive admission policy in the set; or, determining a set of admission policies corresponding to each of the one or more request classes and selecting an admission policy no more restrictive than the least restrictive admission policy in the set.

13. The computer program product in accordance with claim 1, wherein the plurality of possible request classes is alterable by the application.

14. The computer program product in accordance with claim 1, wherein the admission policy corresponding to at least one of the plurality of request classes is alterable by the application.

15. The computer program product in accordance with claim 1, wherein the computing system uses the computer program product to filter incoming application requests for a plurality of applications.

16. The computer program product in accordance with claim 1, wherein the computing system uses the computer program product to filter incoming application requests for a plurality of instances of the same application, wherein the admission policy also is relevant to which of the plurality of instances is to handle the incoming application request if admitted.

17. A method for a computing system to filter at least some incoming application requests for an application such that some application requests are rejected, and some application request are accepted, the method comprising:
an act of receiving a first application request, wherein the application request includes a token issued by the application;
an act of classifying the first application request as being of a particular first subset of one or more request classes of a plurality of possible request classes;
an act of determining a first admission policy to apply based on the particular first subset of one or more request classes corresponding to the first application request, wherein the first admission policy is dependent at least in part upon content of the token included within the first application request;
an act of applying the determined first admission policy for the first application request, the application of the first admission policy resulting in an acceptance of the first application request;
an act of receiving a second application request;
an act of classifying the second application request as being of a particular second subset of one or more request classes of a plurality of possible request classes;
an act of determining a second admission policy to apply based on the particular second subset of one or more request classes corresponding to the second application request; and
an act of applying the determined second admission policy for the second application request, the application of the second admission policy resulting in a rejection of the second application request.

18. A method in accordance with claim 17, further comprising:
an act of receiving a third application request;
an act of classifying the third application request as being of a particular third subset of one or more request classes of a plurality of possible request classes;
an act of determining a third admission policy to apply based on the particular third subset of one or more request classes corresponding to the third application request; and
an act of applying the determined third admission policy for the third application request, the application of the third admission policy resulting in a deferral of the third application request.

19. A method in accordance with claim 18, further comprising:
after a period of time, an act of reevaluating the third application message to determine whether to accept or reject the third application message.

20. A non-transitory computer program product comprising one or more physical non-transitory computer-readable media having thereon computer-executable instructions that, when executed by one or more processors of the computing system, cause the computing system to filter at least some incoming application requests for a web service such that some application requests are rejected, some application requests are accepted, and some application request are deferred, by performing the following for each of the at least some incoming application requests:
an act of classifying the application request as being of a particular subset of one or more request classes of a plurality of possible request classes, wherein the plurality of possible request classes may be altered, wherein the subset of request classes are classified as corresponding to the application request based at least in part on a token issued by the web service, the token provided within the application request, but which token is decipherable based on information shared by the computing system and the web service, but the shared information not being known by the issuer of the application request;
an act of determining an admission policy to apply based on the particular subset of one or more request classes corresponding to the application request, wherein the admission policy corresponding to the plurality of request classes may also be altered;
an act of applying the determined admission policy for the application request, the application of the admission policy having at least three possible outcomes including 1) rejecting the application request to thereby not forward the application request to the web service, 2) accepting the application request to thereby forward the application request to the web service, or 3) deferring the application request until a later time, wherein the deferred application message is drawn at a future times from the deferred message pool for further consideration.
